(19) United States
(12) Patent Application Publication
(10) Pub. No.: US 2006/0241797 A1
(43) Pub. Date: Oct. 26, 2006

(54) Method and apparatus for optimizing reproduction of audio source material in an audio system

(76) Inventors: Larry Vincent Craig, Plymouth, MI (US); Mark William Ziemba, Livonia, MI (US)

Correspondence Address: Laurence S. Roach. Esq., 776 Highway 74 South, Peachtree City, GA, 30269, US

(21) Appl. No.: 11/357,328

(22) Filed: Feb. 17, 2006

Related U.S. Application Data
(60) Provisional application No. 60/653,870, filed on Feb. 17, 2005.

(51) Int. Cl. G06F 17/00

(52) U.S. Cl. 700/94

(57) ABSTRACT

The present invention includes a method of and apparatus for optimizing the reproduction by an audio system of audio source content. The method includes the process of determining the configuration of the audio system and the process of determining the format of the audio source content. Mixing parameters are determined dependent at least in part upon the configuration of the audio system and the format of the audio content. The mixing parameters are applied to the audio source content to create mixed signals optimized for reproducing the particular audio format on the audio system.

### CROSS-REFERENCE TO RELATED APPLICATIONS

This application claims the benefit of U.S. Provisional Patent Application Ser. No. 60/653,870, filed 17 Feb. 2005 and entitled DYNAMIC MIXING OF MULTI-CHANNEL AUDIO SOURCE MATERIAL.

### FIELD OF THE INVENTION

The present invention relates generally to the playback and/or reproduction of audio source material. More particularly, the present invention relates to optimizing the reproduction of audio source materials of a variety of formats based at least in part upon the format of the audio source material and the characteristics of the system on which the source material is being reproduced.

### DESCRIPTION OF THE RELATED ART

Advances in the methods and technologies used for recording and broadcasting audio content, such as music, along with advances in the systems and methods used to reproduce such audio content have combined to raise the expectations of listeners. Listeners to recorded and/or broadcast audio content are simply no longer willing to accept the reproduction of undesirable artifacts of the recording and/or reproduction processes, such as, for example, inconsistent volume/recording levels, unnatural tonal balance, hiss, pops and/or crackles. Rather, the processes of recording and reproduction are expected by today's listeners to be virtually transparent to the listening experience.

However, the same above-referenced technological advancements in recording, broadcasting and reproducing audio content can, at times, result in a listening experience that is, although still of relatively high quality, less than optimal. Recorded audio content is available in many different formats, such as, for example, conventional two-channel or multi-channel stereo format, in various resolutions and sampling rates, and may be encoded according to one of several surround sound encoding schemes. Similarly, systems for the reproduction of recorded audio content can be configured in many different ways, such as, for example as two-channel or multi-channel systems, with different sampling rates and/or resolutions, and may be capable of decoding only a selected few of the available encoding schemes. Thus, somewhat of a mismatch may occur when audio content recorded in a first format is reproduced on a system that is more ideally suited to reproduce audio content recorded in a different or second format.

Such a mismatch exists, for example, when audio content recorded in a conventional two channel format (without any surround sound encoding) is reproduced on a system that is capable of decoding several surround sound encoding schemes and which is ideally suited for reproducing multi-channel sound. Conversely, a mismatch also exists when, for example, audio content recorded in a six channel format and encoded in a surround sound format is reproduced on a system having only two output channels or speakers.

Yet another mismatch may occur when using a multi-zone multi-source system, i.e., a system that enables listeners in different zones to select the same or different sources of audio content for reproduction within their respective zones. Multi-zone multi-source systems include multiple channels or speakers in different locations (or zones) as well as multiple sources which may be in the same or in different zones/locations. Multi-zone multi-source systems are becoming especially common in automobiles, other vehicles, and in homes.

Multi-zone multi-source systems are often user-configurable to reproduce a single source on all channels or zones (thereby functioning as a multi-zone single-source system) or different/selected sources in corresponding zones (thereby functioning as a multi-zone, multi-source system). For example, in a multi-zone multi-source system a rear seat or rear zone passenger that desires to listen to recorded audio content, such as a compact disc, through the speakers (or headphones) corresponding to that zone does so by selecting the compact disc player as the source for that zone. Similarly, a front seat or zone passenger that desires to listen to broadcast audio content, such as AM radio, through the speakers (or headphones) corresponding to that zone does so by selecting the radio as the audio source for that zone.

The different zones within a multi-zone multi-source system are likely to have different characteristics, such as, for example, different numbers and varying placement of speakers, speakers with different frequency response characteristics, and different acoustical properties. Thus, a mismatch may occur between the format in which the audio content is recorded and the characteristics of one or more zones in a multi-zone system. Further, one configuration of a multi-zone system may be installed within several different types or models of vehicles, thereby potentially creating a further mismatch between the system and the vehicle acoustical properties that likely vary from vehicle model to model.

The above-described mismatches can result in audio reproduction that is less than optimal. For example, certain portions of the audio information may not be faithfully reproduced, or may not be reproduced at all, when audio content encoded in a multi-channel surround sound format is reproduced on a two-channel system. Similarly, and as a further example, a multi-channel system is not optimally utilized when used to reproduce audio content in conventional stereo format.

Therefore what is needed in the art is a method and apparatus for improving the reproduction of audio content of a first format on a system that is tailored to reproduce audio content of a different or second format.

Furthermore, what is needed in the art is a method and apparatus for improving the reproduction of audio content by a selected zone of a multi-zone system.

Moreover, what is needed in the art is a method and apparatus for reducing the mismatch that may occur between a system for reproducing audio content and the vehicle in which the system is installed.

### SUMMARY OF THE INVENTION

The present invention provides a method and apparatus for optimizing reproduction of audio source material in an audio system.

The invention comprises, in one form thereof, a method of optimizing the reproduction by an audio system of audio source content. The method includes the process of determining the configuration of the audio system and the process of determining the format of the audio source content. Mixing parameters are determined dependent at least in part upon the configuration of the audio system and the format of the audio content. The mixing parameters are applied to the audio source content to create mixed signals optimized for reproducing the particular audio format on the audio system.

An advantage of the present invention is that the full capabilities of an audio system configuration are utilized.

A further advantage of the present invention is that the loss of audio content during reproduction is minimized.

### BRIEF DESCRIPTION OF THE DRAWINGS

The above-mentioned and other features and advantages of the present invention, and the manner of attaining them, will become apparent and be better understood by reference to the following description of one embodiment of the invention in conjunction with the accompanying drawings, wherein:

FIG. 1 is a block diagram of one embodiment of an audio system of the present invention operably installed in an exemplary environment;

FIG. 2 is a second block diagram of the audio system of FIG. 1;

FIG. 3 is a flow diagram of one embodiment of a method of the present invention for optimizing reproduction of audio source material in an audio system;

FIG. 4 illustrates a first exemplary operational condition of the apparatus of FIGS. 1 and 2 and of the method of FIG. 3; and

FIG. 5 illustrates a second exemplary operational condition of the apparatus of FIGS. 1 and 2 and of the method of FIG. 3.

Corresponding reference characters indicate corresponding parts throughout the several views. The exemplifications set out herein illustrate a preferred embodiment of the invention, in one form, and such exemplifications are not to be construed as limiting in any manner the scope of the invention.

### DETAILED DESCRIPTION

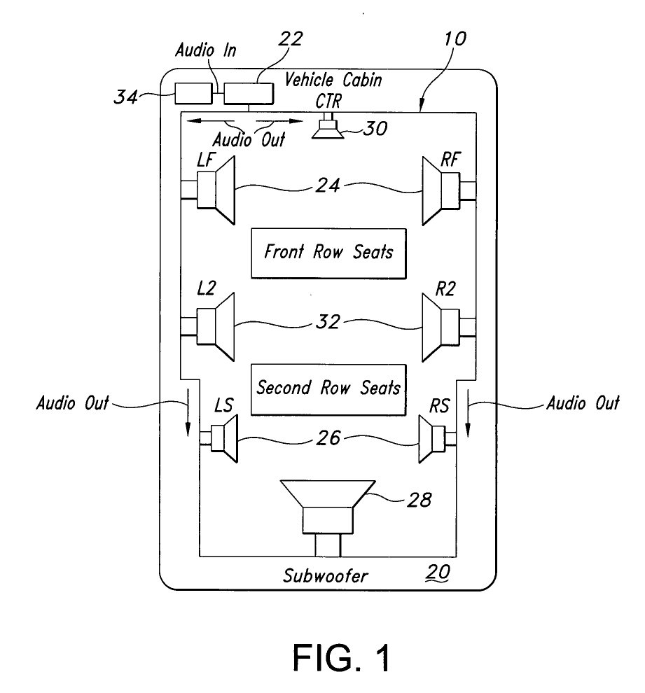

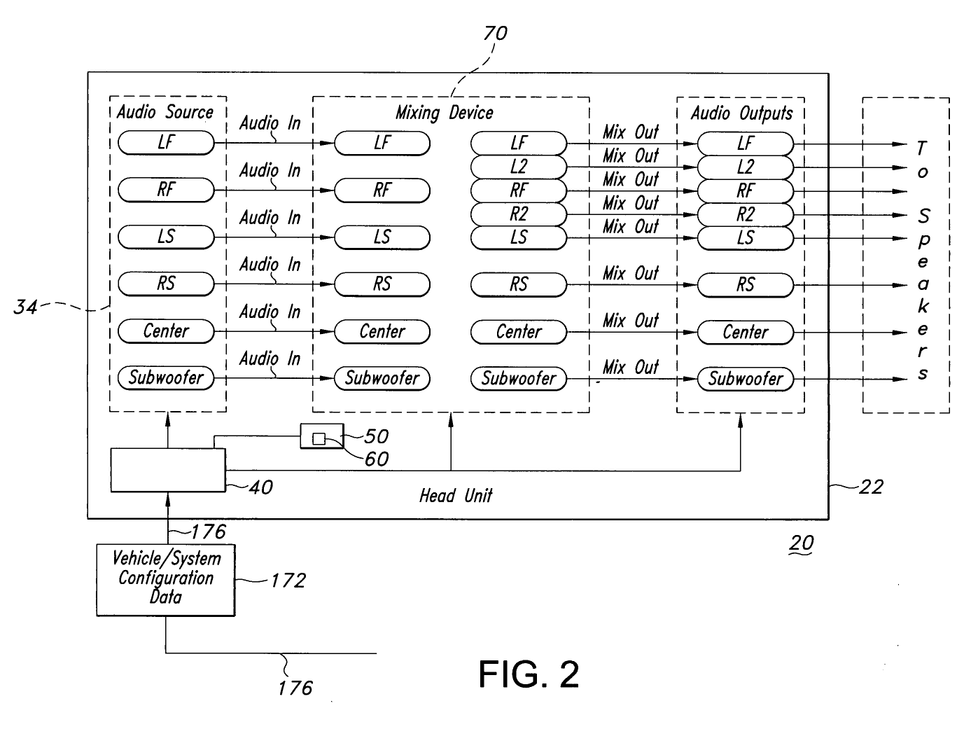

Referring now to the drawings and particularly to FIGS. 1 and 2, there is shown a block diagram of an audio system of the present invention. Audio system 10 operates and/or is installed in an environment 20, such as, for example an automobile or other motor vehicle, having certain acoustical characteristics and properties. Audio system 10 includes head unit 22, front speakers 24, rear speakers 26, subwoofer 28, center speaker 30, second-zone speakers 32, and audio source devices 34. It should be understood, however, that the foregoing specific configuration of audio system 10 and its subsystems and/or components is merely exemplary and in no way limits the scope of the present invention.

Generally, as is more particularly described hereinafter, head unit 22 processes audio signals dependent at least in part upon the acoustical characteristics and properties of environment 20, including the specific configuration of audio system 10 and its associated subsystems and/or components. Further, as is also more particularly described hereinafter, head unit 22 processes audio signals based at least in part upon the format of the audio source being reproduced.

Front speakers 24, rear speakers 26, subwoofer 28, center speaker 30, second-zone speakers 32, and audio source 34 are electrically interconnected with head unit 22. Front speakers 24, rear speakers 26, subwoofer 28, center speaker 30, second-zone speakers 32 receive respective electrical signals AUDIO_{OUT} from head unit 22, which are converted by speakers 24, 26, 28, 30 and 32, or some combination thereof, into sound for presentation to one or more listeners. Speakers 24, 26, 28, 30 and 32, or some subset thereof, are sometimes referred to hereinafter as the output channels of audio system 10.

Audio source devices 34 (only one shown), such as, for example, an AM/FM radio tuner, a satellite radio receiver, a digital video disc player, a compact disc player, etc., provide input signals representative of audio information and/or content to head unit 22. More particularly, audio source devices 34 convert audio source material, such as that contained on a compact disc or audio tape, into one or more respective audio signals AUDIO_{IN} that are received by head unit 22. Audio source devices 34 can be integral with, separate from, and/or remote to head unit 22. The one or more respective audio signals AUDIO_{IN} reproduced by audio source device 34 are sometimes referred to hereinafter as the input or source channels of audio system 10 and/or source 34.

Head unit 22, as best shown in FIG. 2, further includes microprocessor 40, memory 50, software 60 and mixing/amplifying unit 70. Microprocessor 40 is a conventional microprocessor or microcontroller, such as, for example, a [insert manufacturer and model number] that executes the instructions embodied within software 60. Memory 50, such as, for example, non-volatile read-only memory or hard disc drive, electronically stores software 60, and is accessible by and/or interconnected with microprocessor 40. Software 60 includes computer-readable and executable instructions which, at least in part, control the processing of audio signals AUDIO_{IN} by head unit 22. Software 60 resides and is electronically stored by, on, or within memory 50.

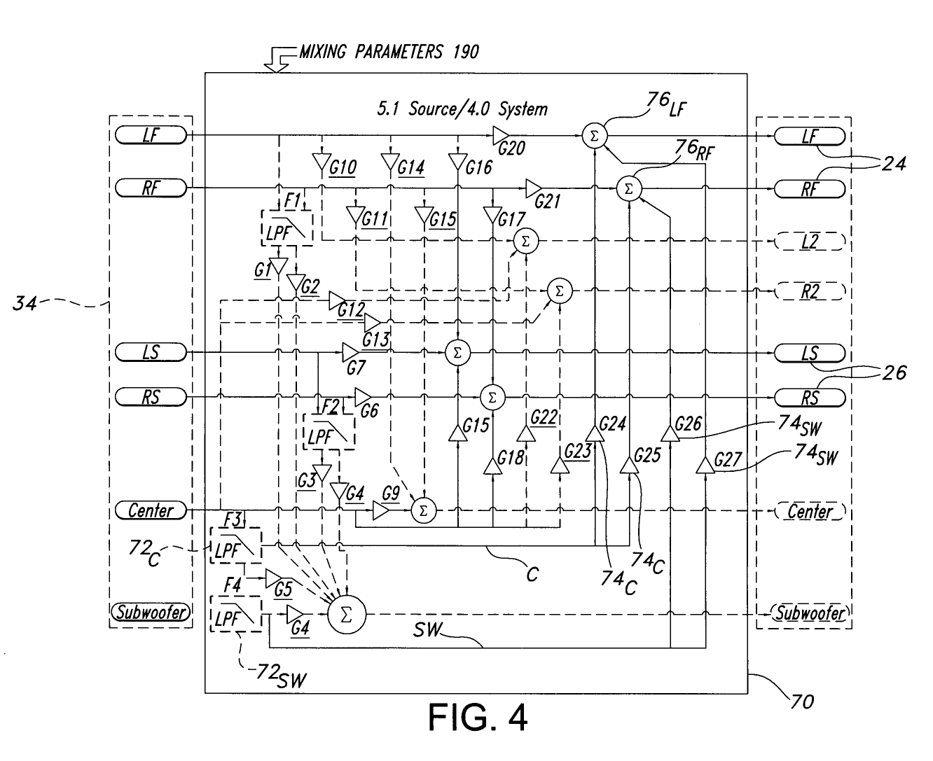

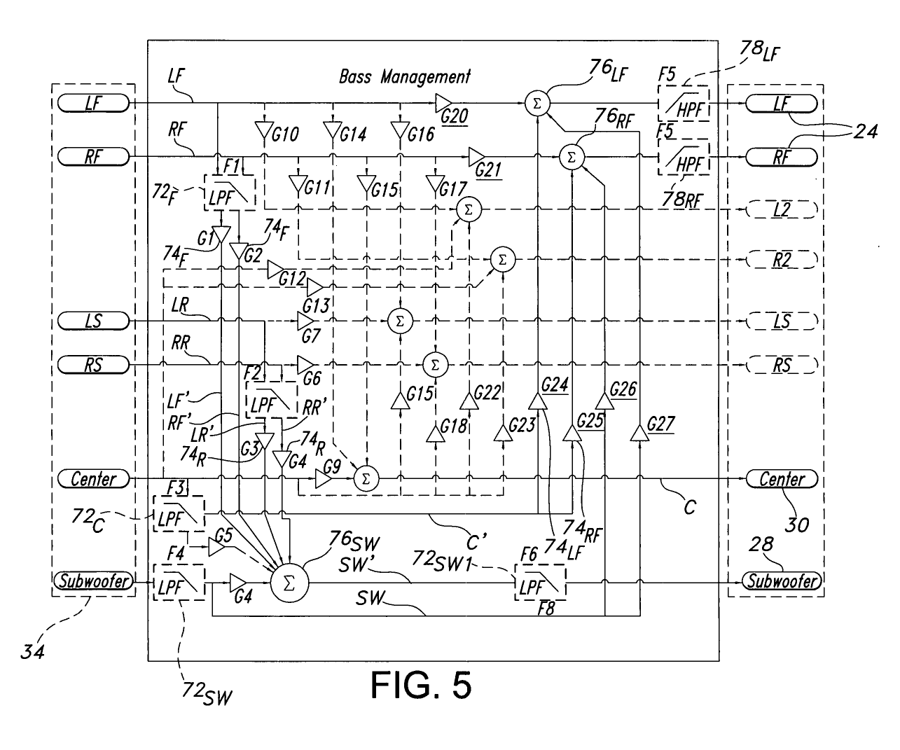

Mixing/amplifying unit 70, which may be integral with and/or remote or separate from head unit 22, mixes, amplifies, otherwise processes and transforms audio signals AUDIO_{IN} to signals MIX_{OUT}. Mixing/amplifying unit 70 (hereinafter sometimes referred to as mixing unit) is preferably configured as one or more digital signal processor (DSP) integrated circuits and includes, as best shown in FIGS. 4 and 5, a plurality of configurable variable parametric signal processing blocks, such as, for example, filters 72, general purpose gain or amplification blocks 74, summation and/or subtraction circuits 76, etc., interconnecting the audio channels of source 34 with audio channels of system 10, as is known in the art. Mixing unit 70 of head unit 22 processes, dependent at least in part upon the configuration of audio system 10 and the format of the audio content being reproduced, the audio signals AUDIO_{IN} and produces signals MIX_{OUT} to thereby optimize the reproduction of the audio content.

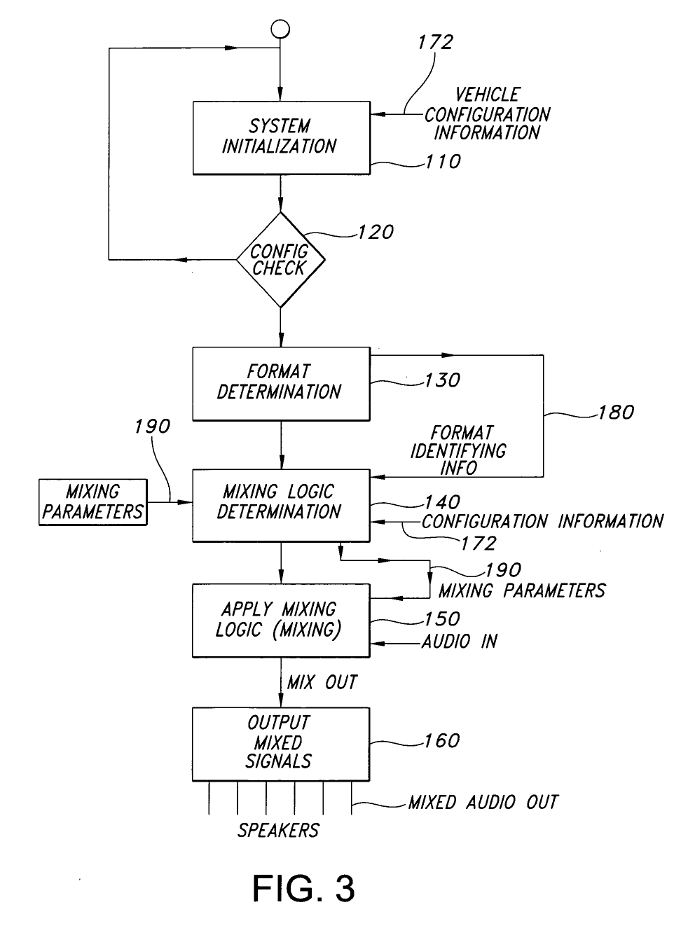

Referring now to FIG. 3, there is shown a flow diagram of one embodiment of a method of the present invention for optimizing reproduction of audio source material in an audio system. Method 100 includes the processes of system initialization 110, system configuration check 120, audio format determination 130, mixing logic determination 140, apply mixing logic 150 and output mixed content 160.

System initialization process 110 is executed at initial power-up of head unit 22. System initialization process 110 also occurs at subsequent power-up sequences of head unit 22 when there has been a change, or there is some indication that a change has occurred, in the configuration of audio system 10 and/or environment 20. Optionally, system initialization process 110 is manually activated by a reset operation, such as, for example, by inserting a special compact disc or by actuating a predetermined sequence of input keys (not shown) on head unit 22.

System initialization process 110 includes configuration information 172 being read or otherwise retrieved by or provided to head unit 22. Configuration information 172 is indicative of the configuration of audio system 10 and the characteristics of environment 20. More particularly, configuration information 172 includes information characterizing the configuration of audio system 10 and environment 20, such as, for example, the number of speakers, the physical placement of speakers, the size, and acoustical characteristics of environment 20, and the available audio source devices 34, etc.

Configuration information 172 is read by and/or provided to head unit 22 via communication and/or entertainment bus 176 (FIG. 2) of environment 20 which is electrically interconnected with head unit 22. More particularly, as audio system 10 is installed into environment 20, configuration information 172 is placed upon communication and/or entertainment bus 176 and is thus made available to head unit 22. Head unit 22, in turn, picks or reads configuration information 172 from bus 176 and stores configuration information 172 in non-volatile memory 50 or other suitable memory (not shown). Alternatively, head unit 22 is configured to query the components of audio system 10 which respond to the query by placing on bus 176 electronic signals and/or data that communicate the presence of the component devices and their associated information, such as, for example, its function, characteristics, and status.

In the specific and exemplary context of environment 20 being an automotive or motor vehicle environment, system bus 176 as is known to those of ordinary skill in the art carries electronic signals to, from and between electronic equipment carried on the vehicle and, further, provides access to additional information, such as the vehicle identification number, which can serve as a look-up or reference piece of information further enabling the determination of configuration information 172.

Once configuration information 172 is received by head unit 22 and system initialization process 110 is complete method 100 proceeds to execute system configuration check process 120.

System configuration check process 120 includes a check to confirm whether there has been either a change in the configuration of audio system 10 and/or environment 20. More particularly, when there has been either a change in the configuration of audio system 10 and/or environment 20 an indication thereof is read by or otherwise provided to head unit 22. For example, in the event that head unit 22 has been removed from environment 20 and installed in a new vehicle or power disconnected from head unit 22, system configuration check process 120 determines, such as, for example, via a flag being set or interrupt signal being issued, that such a change or event has occurred and method 100 again executes system initialization process 110. If no such change is indicated or has occurred, and if system initialization process 110 has not been manually activated, method 100 executes audio format determination process 130.

Audio format determination process 130 determines the characteristics and properties of the audio content being, or about to be, reproduced by audio system 10. More particularly, audio format determination process 130 examines the audio content being or about to be reproduced by the active or selected audio source 34 to determine the format of that audio content, including source type and channel allocation information. Channel allocation information includes not only the number of channels but also generally indicates the type or characteristic of the audio content on each of those channels. The channel allocation information is critical because a 3, 4, or 5 channel source type can have multiple channel allocations. For example, a 5 channel source can be allocated as front and rear or surround channels with a subwoofer channel (a 4.1 allocation) or as front, rear and center channels. Thus, knowing the channel allocation (i.e., which channels contain audio content) of the audio source content is an important factor in determining the optimum configuration of mixing device 70.

For example, audio format determination process 130 examines the audio content being or about to be reproduced to determine whether its format is, monophonic, two-channel stereophonic, other multi-channel, multi-channel surround sound encoded, etc. Dependent at least in part upon the format of the audio content, audio format determination process 130 determines and issues format identifying information 180 to determining mixing logic process 140.

Once the format of the audio content is determined and audio format determination process 130 is complete, method 100 executes mixing logic determination process 140. Mixing logic determination process 140 dependent at least in part upon configuration information 172 and format identifying information 180 accesses predetermined mixing parameters 190 stored within memory 50.

Generally, mixing parameters 190 include a plurality of data sets each of which corresponds to one or more audio format types. More particularly, based at least in part upon configuration information 172 and format identifying information 180 a particular set of predetermined mixing parameters 190 is identified. The mixing parameters 190 include signal processing and other coefficients that determine, at least in part, the parametric settings of the variable parametric signal processing blocks of mixing unit 70, i.e., the levels of gain, the filtering characteristics, mixing levels, and other coefficients that are applied to the audio signals being processed by the applying mixing logic process 150.

Applying mixing logic process 150 generally includes the application of mixing parameters 190 to the variable parametric signal processing blocks and, thus, to the audio signals being processed by audio system 10. More particularly, mixing parameters 190 are applied to the variable parametric signal processing blocks which, in turn, mix, e.g., route, redirect, amplify, attenuate, emphasize, de-emphasize, filter, combine, split apart, phase, and otherwise process and transform signals AUDIO_{IN} to signals MIX_{OUT}. As will be understood by one of ordinary skill in the art, signals MIX_{OUT} may undergo further processing, such as, for example, amplification, prior to being issued or may issue directly to speakers 24, 26, 28, 30 and 32, or some combination thereof.

Outputting mixed content process 160 generally includes providing the signals to the various speakers for presentation to the listener. More particularly, mixed audio signals MIX_{OUT} are either provided directly to or are further processed, such as, for example, amplified, speakers 24, 26, 28, 30 and 32, or some combination thereof for presentation to a listener or listeners in such a way as to provide an optimum listening experience to the listener of audio system 10.

The following examples illustrate the execution of method 100 by audio system 10 and assume that system initialization process 110 has previously been completed.

Referring now to FIG. 4, audio source 34 is shown on the left and is reproducing or is about to reproduce audio content of a six channel format. Thus, six channels of audio information are being or about to be provided to mixing unit 70. Audio system 10, however, includes only two front speakers 24 and two rear speakers 26 and is therefore best suited to reproduce four channels of audio information. Audio system 10 is not ideally suited or intended to reproduce six channels of audio information. Thus, there exists somewhat of a mismatch between the six channel format of the audio content/source and the four channel configuration of the audio system. This mismatch is indicated in FIG. 4 by showing second zone speakers 32, center speaker 30, subwoofer 28 and associated signal paths in mixing unit 70 being shown in dashed lines.

In this first example, system initialization process 110 reads and/or otherwise determines configuration information 172. Thus, the number of channels and locations of speakers, etc., is known by audio system 10. Similarly, audio format determination process 130 determines the format identifying information 180 which indicates that the audio content being, or about to be, reproduced by audio system 10 includes (in this example) six channels of audio content. Mixing logic determination process 140, dependent at least in part upon configuration information 172 and format identifying information 180, accesses memory 50 to retrieve a corresponding set of mixing parameters 190. Mixing parameters 190 are retrieved from memory 50 by microprocessor 40. Applying mixing logic process 150 applies mixing parameters 190 to the variable parametric signal processing blocks of mixing unit 70 and, thus, to the audio signals being processed by audio system 10.

Generally, mixing parameters 190 are applied to the variable parametric signal processing blocks of mixing unit 70 to optimize the reproduction of the six channels of audio content through the four channels that are available in audio system 10. More particularly, in the present example, the audio source contains six channels of audio content, i.e., left and right front channels, left and right rear channels, a center channel and a subwoofer channel. Audio system 10, however, includes only left and right front channels and left and right rear channels, but is not equipped with a subwoofer or center channel. Thus, without the apparatus and/or method of the present invention, the audio information on the subwoofer and center channel would be reproduced in a less than optimal manner, if at all. The present invention solves this problem as is further described below.

Generally, mixing parameters 190 are applied to mixing unit 70 which, in turn, redirects and/or mixes the audio information contained in the subwoofer and center channels of the audio source content to one or more existing output channels of audio system 10 (i.e., front speakers 24 and/or rear speakers 26) that are best-suited for reproducing that content. More particularly, and as best shown in FIG. 4, mixing unit 70 dependent at least in part upon mixing parameters 190, redirects the subwoofer channel SW of the audio source content via a respective low pass filter 72_{SW} and respective summation circuits 76_{LF} and 76_{RF} to, in this example, the left front and right front channels or speakers 24 of audio system 10.

The frequency characteristic of low pass filter 72_{SW} is established by the application of appropriate mixing parameters 190 (i.e., coefficient loading) to mixing unit 70 to thereby enable passage of a range of frequencies to front speakers 24 that optimizes reproduction of the audio content that would otherwise be reproduced by the subwoofer speaker. For purposes of this example, since audio system 10 includes no subwoofer speaker(s), the frequency characteristic of low pass filter 72_{SW} is established by the application to mixing unit 70 of mixing parameters 190 that cause full-bandwidth subwoofer channel audio content to be passed to the full-range front speakers 24. In effect, low pass filter 72_{SW} is bypassed by the application of appropriate mixing parameters 190 to mixing unit 70.

Similarly, the center channel C audio source content is directed by mixing unit 70, dependent at least in part upon mixing parameters 190, via a low pass filter 72_{C} and respective summation circuits 76_{LF} and 76_{RF} to, in this example, the left front and right front channels or speakers 24 of audio system 10. The frequency characteristic of low pass filter 72_{C} is established by the application of appropriate mixing parameters 190 (i.e., coefficient loading) to mixing unit 70 to thereby enable passage of a range of frequencies to front speakers 24 that optimizes reproduction of the center channel audio content. For purposes of this example, since audio system 10 includes no center channel speaker(s), the frequency characteristic of low pass filter 72_{C} is established by the application to mixing unit 70 of mixing parameters 190 that cause full-bandwidth center channel audio content to be passed to the full-range front speakers 24. In effect, low pass filter 72_{C} is bypassed by the application of appropriate mixing parameters 190 to mixing unit 70.

The gain of gain stages 74_{C} and 74_{SW} in the center C and subwoofer SW channels, respectively, of mixing unit 70 is also adjusted via the application of appropriate mixing parameters 190 to mixing unit 70 to thereby compensate for the lack of a center and subwoofer channel speakers 30 and 28, respectively. Thus, the reproduction of six channels of audio source content is optimized for playback on four output channels by the audio system and/or the method of the present invention.

Referring now to FIG. 5, audio source 34 is again shown on the left. In this example, audio source 34 is reproducing or is about to reproduce audio content having a six channel format. Thus, six channels of audio information are being or about to be provided to mixing unit 70. Audio system 10, like audio source 34, includes six channels, i.e., two front speakers 24, two rear speakers 26, a center channel 30 and a subwoofer 28. However, in this example, audio system 10 is configured with a center channel speaker 30 and rear speakers 26 having a limited or restricted low-frequency response. Thus, in order to optimize reproduction of the audio content, mixing unit 70 generally shifts the low-frequency content that would otherwise be directed to the center and rear speakers 30 and 26, respectively, to existing speakers that are best-suited to reproduce those frequencies. Such an approach is sometimes referred to hereinafter as “bass management”.

It should be particularly noted that the channel/signal flow paths shown as dashed lines in FIG. 5, although still viable channel/signal flow paths, in order to divert the attention of the reader away from those dashed-line channel/signal flow paths and to thereby direct the attention of the reader to the channel/signal flow paths shown in solid lines. It is the channel/signal flow paths shown in solid lines which comprise the adaptive flow paths of the signal processing that occurs in mixing unit 70 under the specific conditions of this second example.

In this second example, system initialization process 110 reads and/or otherwise determines configuration information 172. Thus, the number of channels and locations of speakers, including the limited low frequency response of the center channel 30 and rear channel 26 speakers, is known by audio system 10. Similarly, audio format determination process 130 determines the format identifying information 180 which indicates that the audio content being, or about to be, reproduced by audio system 10 includes (in this example) six channels of audio content. Mixing logic determination process 140, dependent at least in part upon configuration information 172 and format identifying information 180, accesses memory 50 to retrieve a corresponding set of mixing parameters 190. Mixing parameters 190 are retrieved from memory 50 by microprocessor 40 and applied to mixing unit 70. Applying mixing logic process 150 applies mixing parameters 190 to the variable parametric signal processing blocks of mixing unit 70 and, in turn, to the audio signals being processed by audio system 10.

Generally, mixing parameters 190 are applied by mixing unit 70 to optimize the reproduction of the six channels of audio content in light of the limited low-frequency response characteristic of center channel speaker 30 and rear speakers 26. Thus, without the apparatus and/or method of the present invention, the low-frequency content on the center and rear channels of the audio source 34 would be reproduced in a less than optimal manner, if at all, by audio system 10. The present invention addresses this problem as is further described below.

Generally, mixing parameters 190 are applied to mixing unit 70 which, in turn, redirects and/or mixes the low-frequency audio source content of the center and rear channels to one or more existing output channels of audio system 10 that are best-suited for reproducing that content. More particularly, as best shown in FIG. 5, mixing unit 70 dependent at least in part upon mixing parameters 190 redirects the audio source content of the front channels LF and RF, rear channels LR and RR, and center channel C that is below the cut-off frequency of the low pass filters 72_{F}, 72_{R}, 72_{C}, respectively, to corresponding channels LF′ and RF′, rear channels LR′ and RR′, and center channel C′ and through corresponding gain stages 74_{F}, 74_{R}, 74_{C} into summation circuit 76_{SW}.

The low-frequency audio source content of channels LF′, RF′, LR′, RR′ and C′ is summed by summing circuit 76_{SW} and is routed through a low-pass filter 72_{SW1} having a cut-off frequency that is a predetermined amount lower than the cut-off frequency of low-pass filters 72_{F}, 72_{R}, 72_{C}. The cut-off frequency of low-pass filter 72_{SW1} is dependent at least in part upon mixing parameters 190 which, in turn, are dependent at least in part upon the frequency response characteristics of subwoofer 28. Thus, the only frequencies that are passed from LF′, RF′, LR′, RR′ and C′ through low-pass filter 72_{SW1} to subwoofer 28 are those frequencies that are optimally reproduced by subwoofer 28.

Additionally, the low-frequency audio content of center channel C that is below the cut-off frequency of low-pass filter 72_{C}, i.e., the audio content of channel C′, is also directed by mixing unit 70, dependent at least in part upon mixing parameters 190, to summation circuits 76_{LF} and 76_{RF} through corresponding gain stages 74_{LF} and 74_{RF} and into high-pass filters 78_{RF}. The high-pass cut off frequency, i.e., the frequency above which audio content is passed to front speakers 24 is determined via the application of appropriate mixing parameters 190 which, in turn, are dependent at least in part upon the frequency response of front speakers 24. Further, the gain of gain stages 74_{LF} and 74_{RF} is also adjusted via the application of appropriate mixing parameters 190 to compensate for the reduced low-frequency response of the center and rear channel speakers 30 and 26, respectively.

Thus, the reproduction of the low-frequency portions of audio source content is optimized by the audio system and/or method of the present invention in an audio system wherein one or more channels (in this example, the center and rear channels) have a restricted low-frequency response.

In the embodiment shown, audio source device 34 and mixing unit 70 are depicted as being contained within and/or forming a part of head unit 22. However, it is to be understood that, audio system 10 can be alternately configured, such as, for example, with either or both of audio source devices 34 and mixing unit 70 being separate and distinct from head unit 22.

In the embodiment shown, configuration information 172 is described as being read and/or otherwise obtained. However, it is to be understood that the apparatus and method of the present invention can be alternately configured to determine the configuration information via more conventional and/or different means, such as, for example, through discrete logic gates and/or circuitry associated with audio system 10.

1. An audio system for optimizing the reproduction of audio source content within a listening environment, comprising:
at least one audio source device providing one or more audio source channels corresponding to said audio source content;
a microprocessor;
software executable by said microprocessor, said software determining mixing parameters, said mixing parameters being dependent at least in part upon a format of said audio source content, a configuration of said audio system and one or more characteristics of said environment; and
a mixing unit applying said mixing parameters to said one or more audio source channels to thereby produce mixed output signals.

2. The audio system of claim 1, wherein said software includes a system initialization process which determines configuration information, said configuration information indicating at least one of said configuration of said audio system and said one or more characteristics of said environment.

3. The audio system of claim 2, wherein said configuration information is indicative of at least one of the number of speakers connected to said audio system, location of said speakers, frequency response characteristics of said speakers, acoustical characteristics of said environment, and the number and type of said audio source devices.

4. The audio system of claim 2, wherein said environment includes a system bus, said system initialization process includes said microprocessor accessing said system bus to read data indicative of said configuration information.

5. The audio system of claim 4, wherein said data includes a vehicle identification number.

6. The audio system of claim 4, wherein said data includes data supplied by components of said audio system in response to a query from said microprocessor.

7. The audio system of claim 2, wherein said software further includes a system configuration check to determine whether said configuration information has changed.

8. The audio system of claim 1, wherein said software includes a format determination process that determines format identifying information indicative of said format of said audio source content.

9. The audio system of claim 8, wherein said format identifying information indicates at least one of whether said audio source content is monophonic, stereophonic, multi-channel stereophonic, multi-channel surround sound encoded, and the number of channels thereof.

10. The audio system of claim 9, wherein said format identifying information further indicates a channel allocation of said audio source content.

11. The audio system of claim 1, wherein said software includes a mixing logic determination process that determines mixing parameters, said mixing parameters being dependent at least in part upon said format identifying information.

12. The audio system of claim 11, wherein said software further includes an applying mixing logic process that, dependent at least in part upon said mixing parameters, at least one of routes, filters, redirects, amplifies, attenuates, phases and otherwise processes said audio source content to thereby create mix output signals.

13. A method of optimizing the reproduction by an audio system of audio source content, comprising the processes of:
determining a configuration of said audio system;
determining a format of said audio source content;
determining mixing parameters dependent at least in part upon said configuration and said format; and
applying said mixing parameters to said audio source content to thereby create mixed signals.

14. The method of claim 13, wherein said determining a configuration process determines at least one of the number of speakers connected to said audio system, location of said speakers, frequency response characteristics of said speakers, acoustical characteristics of said environment, and the number and type of said audio source devices.

15. The method of claim 13, wherein said determining a configuration process includes accessing a signal bus to read data indicative of the configuration of the audio system.

16. The method of claim 15, wherein said data includes a vehicle identification number.

17. The method of claim 15, wherein said data includes data that is at least one of supplied by and read from components of the audio system.

18. The method of claim 13, wherein said determining a format process determines whether said audio source content is monophonic, stereophonic, multi-channel stereophonic, multi-channel surround sound encoded, and a channel allocation thereof.

19. The method of claim 13, wherein said applying mixing parameters process applies said mixing parameters to at least one of route, filter, redirect, amplify, attenuate, phase and otherwise process said audio source content to thereby create said mixed signals.

20. An audio system for optimizing the reproduction of audio source content within a listening environment, said audio system having a configuration including a number of speakers with respective characteristics, said characteristics including position within said environment and frequency response, said audio source content having a predetermined format, said format including a number of channels of audio content and a channel allocation, said apparatus comprising:
at least one audio source device for transforming said audio source content into one or more audio input signals;
a microprocessor;
software executable by said microprocessor, said software determining mixing parameters, said mixing parameters being dependent at least in part upon said format of said audio source content and said configuration of said audio system; and
a mixing unit applying said mixing parameters to said one or more audio input signals to thereby produce mixed output signals.

21. The audio system of claim 20, wherein said mixing unit comprises one or more digital signal processing integrated circuits, said mixing parameters being applied to said mixing unit.

22. The audio system of claim 21, wherein said mixing unit comprises a plurality of configurable variable parametric signal processing blocks, characteristics of said signal processing blocks being determined at least in part by respective mixing parameters applied thereto.

23. The audio system of claim 22, wherein said variable parametric signal processing blocks include gain blocks, summation blocks and filter blocks, parameters of said signal processing blocks being determined at least in part by corresponding mixing parameters applied thereto.

24. The audio system of claim 20, wherein said environment includes a system bus, said audio system configuration being accessible to said microprocessor via said system bus.

25. A method of optimizing the reproduction of audio source content by an audio system having a predetermined configuration, said method comprising the processes of:
determining a format of said audio source content;
determining mixing parameters dependent at least in part upon said format and in light of said configuration of said audio system; and
applying said mixing parameters to said audio source content to thereby create mixed signals, said mixed signals being optimized for reproduction by said audio system.

26. The method of claim 25, wherein said determining a format process includes determining a channel allocation of said audio content, said mixing parameters being dependent at least in part upon said channel allocation.

27. The method of claim 26, wherein:
said determining mixing parameters process comprises determining a plurality of signal processing coefficients; and
said applying said mixing parameters process comprises applying said signal processing coefficients to a plurality of configurable variable parametric signal processing blocks to thereby determine at least in part characteristics of said signal processing blocks.
